(19) United States
(12) Patent Application Publication
(10) Pub. No.: US 2009/0288041 A1
(43) Pub. Date: Nov. 19, 2009

(54) Methodology to Create a Logical Landing Zone Surrounding an Object to React to Determined HTML Events

(76) Inventors: Amy Herrman Dewar, Durham, NC (US); Nicholas Edward Poore, Durham, NC (US); Robert Charles Leah, Cary, NC (US); Peter Chi-Shing Yim, Raleigh, NC (US)

Correspondence Address: HAMILTON & TERRILE, LLP;IBM RSW, P.O. BOX 203518, AUSTIN, TX, 78720, US

(21) Appl. No.: 12/120,301

(22) Filed: May 14, 2008

(51) Int. Cl. G06F 3/048

(52) U.S. Cl. 715/856

(57) ABSTRACT

A method, system, and computer-usable medium are disclosed for managing elements within a graphical user interface (GUI). Logical landing zones are generated to create non-visible areas of a GUI associated with one or more GUI elements. A mouse cursor is hovered over a first linked element results in a JavaScript onmouseover event. When executed, the mouseover event displays a second, noncontiguous linked element. Moving the mouse away from the first linked element results in an onmouseout event, which activates a first logical landing zone that comprises the second linked element and is contiguous to the first linked element. The second linked element continues to be displayed, and allowing user interaction, as long as the mouse cursor remains within the first linked element or the first logical landing zone.

### BACKGROUND OF THE INVENTION

1. Field of the Invention

Embodiments of the disclosure relate in general to the field of computers and similar technologies, and in particular to software utilized in this field. Still more particularly, it relates to managing elements within a graphical user interface (GUI).

2. Description of the Related Art

The ongoing growth of the Internet and the widespread adoption of its associated technologies have made Web pages a popular means of delivering information. As commonly implemented, Web pages typically include multiple elements, including text, static images (e.g., a graphics file), and animated images (e.g., video), which are displayed within the graphical user interface (GUI) of a browser. One of the advantages of Web pages is the ability to link multiple page elements, or other Web pages, using a hyperlink. A hyperlink specifies the location of the linked element or Web page and may reference another element within the same Web page, the address of a different Web page, or an element on a different Web page. These different Web pages and their associated elements may be located within the same Web site or on a different Web site. Further, the Web sites may reside on the same computer server or on different servers located thousands of miles apart. However, the advantage of being able to link to other elements and Web pages also poses potential drawbacks. There are times when a user may link to one or more different elements or Web pages and then has to retrace their steps to return to their original starting location. In such situations, it can be frustrating for the user when they have no foreknowledge about the linked element or Web page and have to follow the hyperlink to discover its contents.

Current approaches to this issue include displaying descriptive or informative text in a pop-up window because of user interaction with a linked element. As an example, a window may appear superimposed on the Web Page whenever the user's mouse cursor is hovered over the hot area, or image map, of a linked element. Moving the mouse cursor over the hot area or image maps of other linked elements results in the appearance of other superimposed windows. These windows may contain information about the linked element itself or information about a linked-to element or Web page. In some cases, the superimposed windows contain a preview of the contents of a linked-to Web page, including its linked elements. In certain cases, it is possible for the user to leave the superimposed window open and interact with the linked elements that are displayed within the window. As a result of such user interaction, additional windows may be superimposed within the GUI. In a like fashion, the user can then interact with the information or linked elements they contain.

In general, a superimposed window may be made to appear anywhere within a GUI as a result of user interaction with a linked element. However, user interaction with the contents of a superimposed window typically requires that the boundaries of the window either overlap or be contiguous with the hot area or image map of the linked element. Otherwise, the superimposed window will close as the mouse cursor is moved away from the linked element. As an example, a JavaScript onmouseover event is initiated when a user hovers their mouse cursor over a linked element. As a result, a superimposed window appears which will remain open as long as the mouse cursor is hovered over the linked element. The window will continue to remain open as the user moves the mouse cursor into the window if the boundaries of the window either overlap or are contiguous with the hot area or image map of the linked element. The superimposed window will continue to remain open as long as the mouse cursor remains within the boundaries of the window. However, moving the mouse cursor outside of the window's boundaries will result in a JavaScript onmouseout event, causing the superimposed window to close. Likewise, if the superimposed window's boundaries do not overlap or are not contiguous with the hot area or image map of the linked element, or if it takes too long to move the mouse cursor into the window, then the window may close as the result of a JavaScript onmouseout event. In view of the foregoing, it would be advantageous for a user to interact with the contents of a superimposed window whose boundaries do not overlap or are contiguous with the hot area or image map of a linked element.

### BRIEF SUMMARY OF THE INVENTION

The present invention includes, but is not limited to, a method, system, and computer-usable medium for managing elements within a graphical user interface (GUI). In various embodiments, logical landing zones are generated to create non-visible, predetermined areas of a graphical user interface (GUI) associated with one or more elements displayed within the GUI. In one embodiment, the area of a logical landing zone is coupled with the hot areas of two non-contiguous elements to create a single, contiguous area within a GUI. The logical landing zone can then be associated with a function, such as a JavaScript onmouseover event, that is initiated by a user gesture such as hovering a mouse cursor over one of the linked elements.

In one embodiment, moving a mouse cursor over the hot area of a first linked element results in a JavaScript onmouseover event, which then results in the display of a second linked element having a noncontiguous hot area. Moving the mouse cursor outside of the hot area of the first linked element results in a JavaScript onmouseout event that activates a first logical landing zone. The first logical landing zone comprises the hot area of the second linked element and is contiguous to the hot area of the first linked element, which effectively expands the hot area of the second linked element. Accordingly, the second linked element continues to be displayed as long as the mouse cursor remains within the hot area of the first linked element or the first logical landing zone. In another embodiment, the JavaScript onmouseout event results in the application of visual attributes to the hot area of the first linked element.

In yet another embodiment, a second logical landing zone is generated, comprising the hot area of the first linked element and the first logical landing zone. The activation of the second logical landing zone prevents user interaction with linked elements and navigation aids that are located within the defined area of the second logical landing zone. The user's ability to interact with the linked elements is restored once the second logical landing zone is deactivated. In one embodiment, the first and second logical landing zones are deactivated by a JavaScript onmouseout event that is initiated by moving the user's mouse cursor outside of the second logical landing zone. The above, as well as additional purposes, features, and advantages of the present invention will become apparent in the following detailed written description.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary client computer in which the present invention may be implemented;

FIG. 2 is a flowchart for creating logical land zones;

FIGS. 3a-c are a flowchart of an implementation of logical landing zones; and

FIGS. 4a-d show the implementation of logical landing zones within the graphical user interface (GUI) of a browser.

### DETAILED DESCRIPTION

A method, system, and computer-usable medium are disclosed for managing elements within a graphical user interface (GUI). As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could be paper or another suitable medium upon which the program is printed, as the program can be electronically captured by optical scanning of the paper, for instance, or another medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therein, either in baseband or as part of a carrier wave. The computer usable program code may be transmitted using any appropriate medium, including but not limited to the Internet, wireline, optical fiber cable, radio frequency (RF), etc.

Computer program code for carrying out operations of the present invention may be written in an object oriented programming language such as Java, Smalltalk, C++, or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

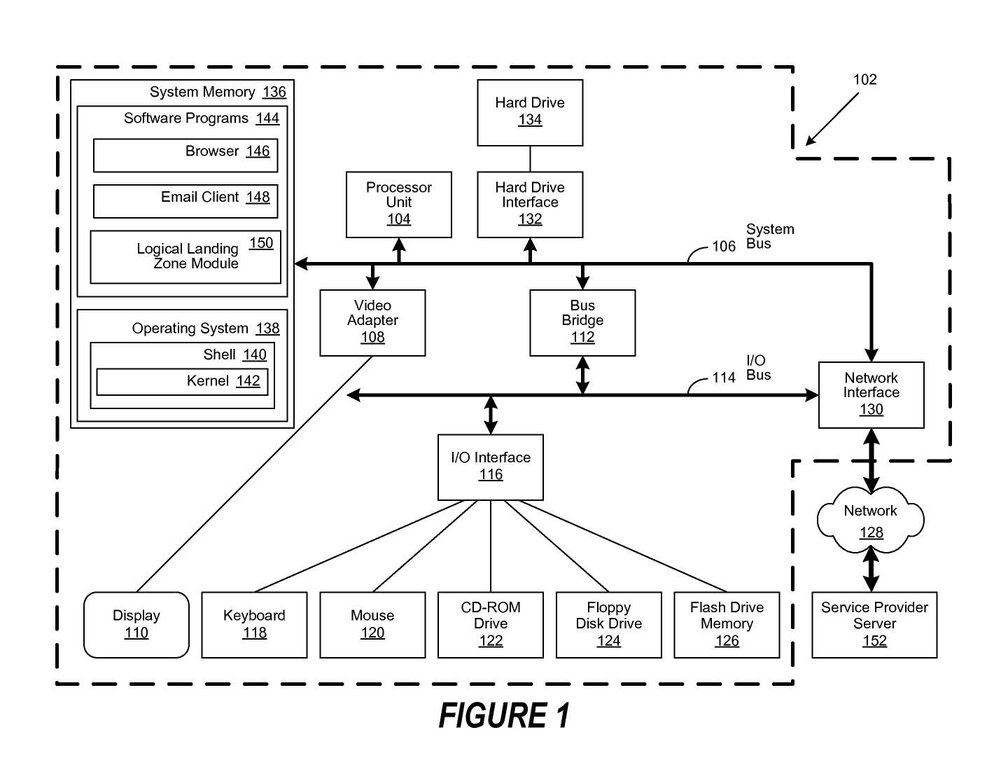

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy, and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and software programs 144, including memory management, process and task management, disk management, and mouse and keyboard management.

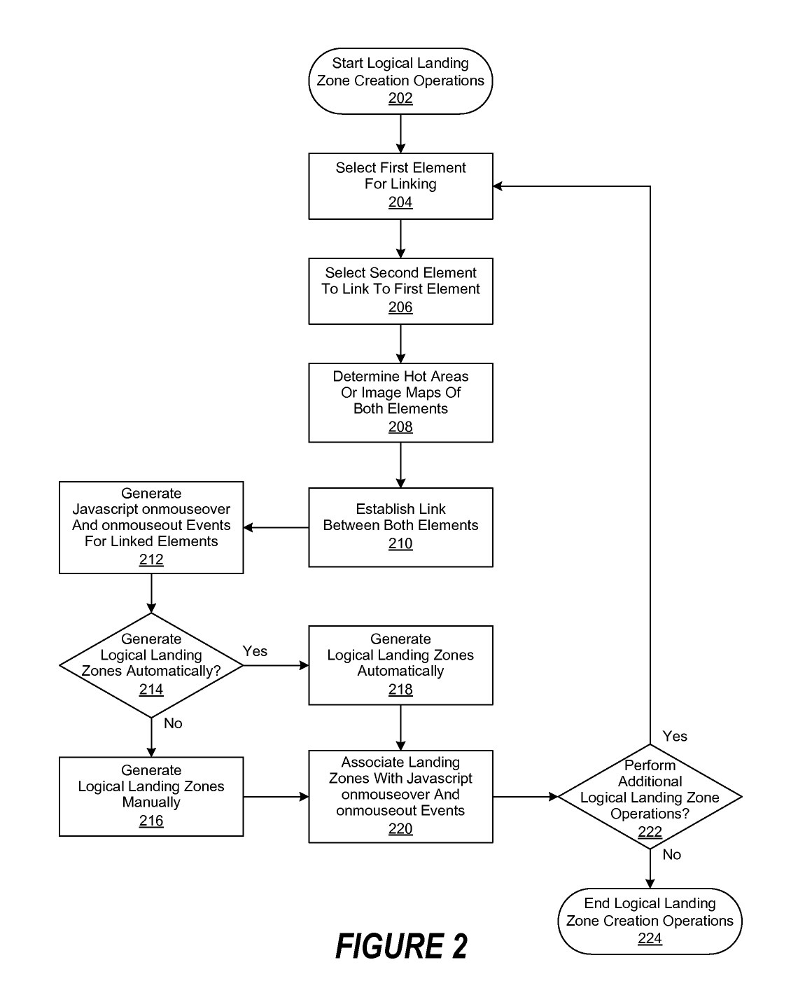

Software programs 144 may include a browser 146 and email client 148. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. Software programs 144 also include a logical landing zone module 150. The logical landing zone module 150 includes code for implementing the processes described in FIGS. 2 through 4 described herein. In one embodiment, client computer 102 is able to download the logical landing zone module 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 is a flowchart for creating logical land zones in accordance with an embodiment of the invention. In this embodiment, logical landing zone creation operations begin in step 202. As used herein, a logical landing zone is a non-visible, predetermined area of a graphical user interface (GUI) associated with one or more elements displayed within the GUI. In one embodiment, the area of a logical landing zone is coupled with the link areas of two non-contiguous elements into a single, contiguous area within a GUI. The logical landing zone can then be associated with function, such as a JavaScript onmouseover event, that is initiated by a user gesture such as hovering a mouse cursor over one of the linked elements. In another embodiment, the logical landing zone is activated, or deactivated, by a JavaScript onmouseout event that is initiated by a user gesture, such as moving a mouse cursor outside of an element's hot area or image map. In yet another embodiment, the activation of a logical landing zone prevents user interaction with linked elements and navigation aids that are located within the defined area of the logical landing zone. The user's ability to interact with the linked elements is restored once the logical landing zone is deactivated. In various embodiments, an element may be text, static images (e.g., a graphics file), and animated images (e.g., video), each of which may be linked to one or more elements.

Referring now to step 204, a first element is selected for linking to a second element. In step 206, a second element is selected to link to the first element. In step 208, the hot areas, or image maps, of the two elements are determined. As used herein, a hot area is defined as an invisible area of the GUI, defined by a set of coordinates, which coincide with an element displayed within the GUI. The hot area is then used to link the element to another element. An image map is also an invisible area of the GUI, likewise defined by a set of coordinates, which allow different areas of an element to be linked to other elements. Once the hot areas or image maps of the two elements are selected, the elements are then linked to one another in step 210 using methods familiar to those of skill in the art.

JavaScript onmouseover and onmouseout events, as described in greater detail herein, are then generated for the linked elements in step 212. In various embodiments, these JavaScript onmouseover and onmouseout events are initiated by user interaction with the linked elements and result in the activation and deactivation of logical landing zones. A decision is then made in step 214 whether the logical landing zones will be generated manually or automatically. If it is decided to generate logical landing zones manually, then they are manually created in step 216. As an example, an area of a logical landing zone may be defined through user gestures, such as mouse operations, in a graphical user interface (GUI). If it is decided to generate logical landing zones automatically, then they are automatically created in step 218. In one embodiment, an algorithm is implemented to automatically define and generate the logical landing zones. In this embodiment, a first element ‘A’ has a defined width(aW) and height(aH) and a defined location within the GUI aX,aY. A second element ‘B’ has a defined width(bW) and height(bH) and a defined location bX,bY within the GUI. Likewise, a first logical landing zone ‘C’ has a defined width(cW) and height(cH) and a defined location cX,cY location within the GUI. A second logical landing zone ‘D’ has a defined width(dW) and height(dH) and a defined location dX,dY location within the GUI.

Accordingly:

```
    if (aY > bY)
        then the location of Element ‘A’ within the GUI is beneath
        Element ‘B’ so the location of logical landing zone ‘D’ within
the GUI is defined as dY(dY < bY)
    endif
    if (aY < bY)
        then the location of Element ‘A’ within the GUI is above
        Element ‘B’so the location of logical landing zone ‘D’ within
the GUI is defined as dY(dY < aY)
    endif
    if (aX < bX)
        then the location of Element ‘A’ within the GUI is to the left of
Element ‘B’
        so the location of logical landing zone ‘D’ within the GUI is
defined as dX(aX < dX <bX)
    endif
    if (aX > bX)
        then the location of Element ‘A’ within the GUI is to the right
of Element ‘B’
        so the location of logical landing zone ‘D’ within the GUI is
defined as dX(bX < dX < aX)
    endif
    define dW, dH such that it contains Element ‘B’
```

define logical landing zone ‘C’ such that it contains all elements ‘A’ and ‘B’ and logical landing zone ‘D’

Once the logical landing zones are defined, either manually in step 216 or automatically in step 218, they are associated with the previously generated JavaScript onmouseover and onmouseout events. A decision is then made in step 222 whether or not to perform additional logical landing zone operations. If so, the process continues, proceeding with step 202. Otherwise, logical landing zone operations are ended in step 224.

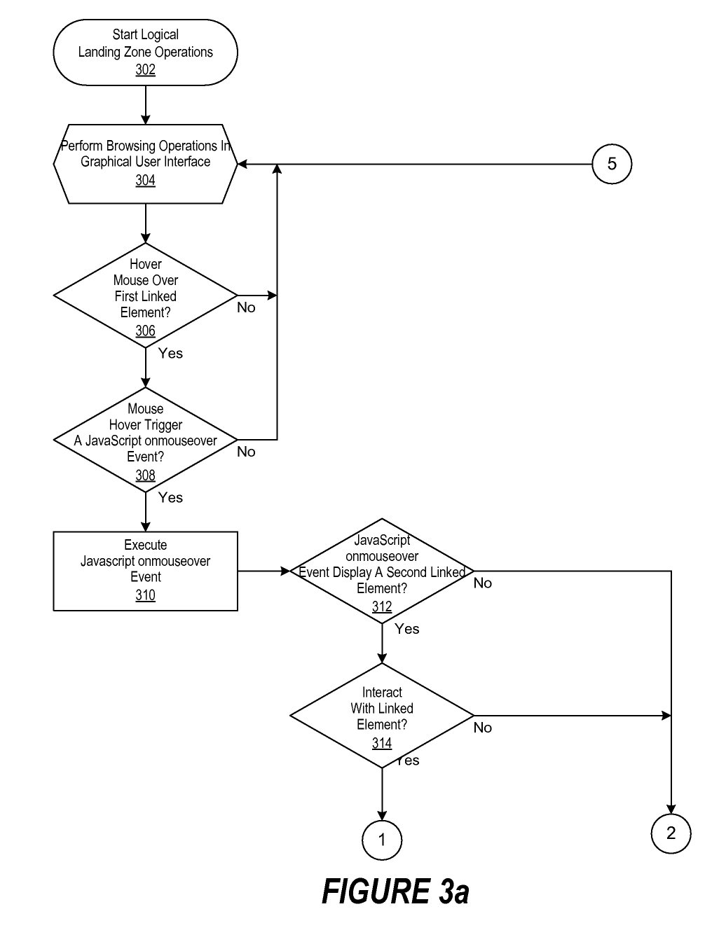

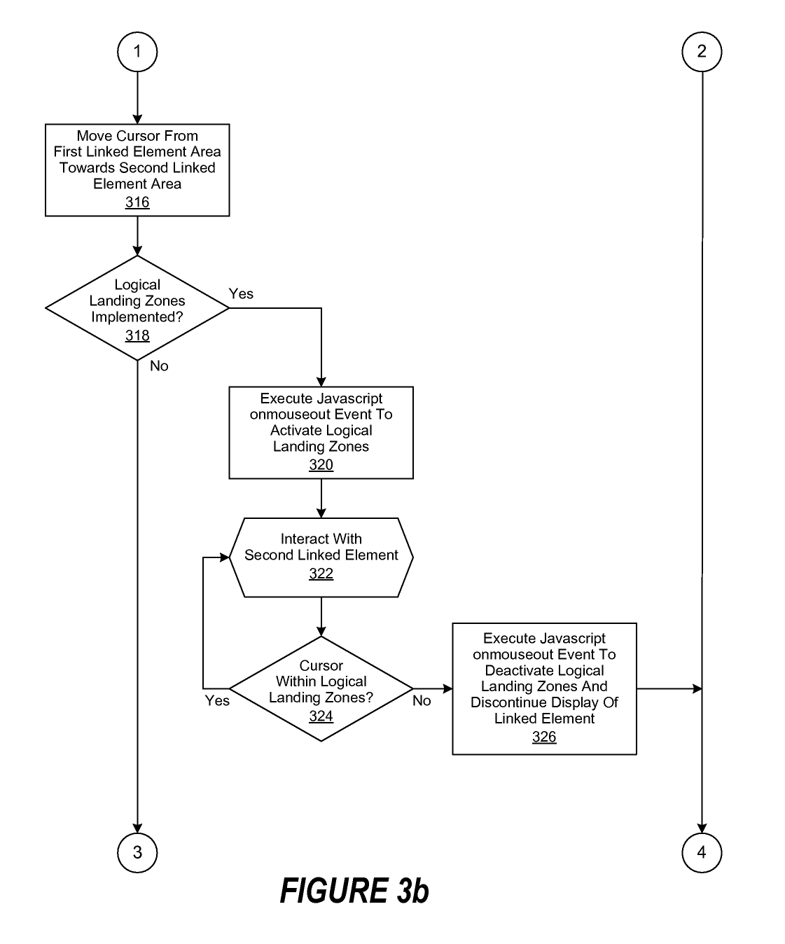

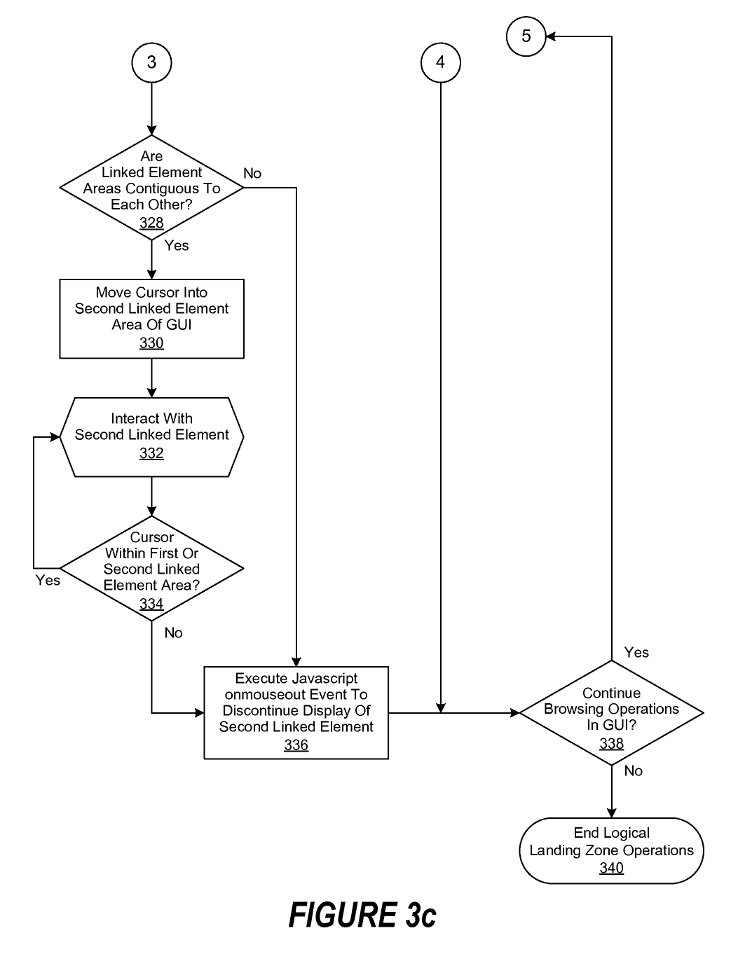

FIGS. 3a-c are a flowchart of an implementation of logical landing zones in accordance with an embodiment of the invention. In this embodiment, logical landing zone operations are begun in step 302, followed by a user performing browsing operations within a graphical user interface (GUI). In one embodiment, the GUI is implemented within a browser, such as a Web browser for browsing Web pages. In another embodiment, the GUI is implemented in a file viewer, such as those familiar to skilled practitioners of the art. As an example, the file viewer may be a stand-alone document viewer or a component of an integrated development environment (IDE).

A decision is then made in step 306 whether a mouse cursor is hovered over a first linked element. If not, browsing operations are continued, proceeding with step 304. If so, a decision is made in step 308 whether the mouse cursor hover triggers a JavaScript onmouseover event. If not, browsing operations continue, proceeding with step 304. If so, the JavaScript onmouseover event is executed in step 310. A decision is then made in step 312 if the execution of the JavaScript onmouseover event results in the display of a second linked element. If not, a decision is made in step 338 whether to continue browsing operations in the GUI. If so, then browsing operations are continued, proceeding to step 302. Otherwise, logical landing zone operations are ended in step 340.

However, if it is decided in step 312 that a second linked element is displayed as a result of the execution of the JavaScript onmouseover event, then a decision is made in step 314 whether the user will interact with the second linked element. If not, a decision is made in step 338 whether to continue browsing operations in the GUI. If so, then browsing operations are continued, proceeding to step 302. Otherwise, logical landing zone operations are ended in step 340. Otherwise, the user's mouse cursor is moved from the hot area or image map of the first linked area towards the hot area or image map of the second linked area. A decision is then made in step 318 whether logical landing zones have been implemented within the GUI. If not, then it is decided in step 328 whether the hot areas or image maps of the first and second linked elements are contiguous to one another. If not, then a JavaScript onmouseout event is executed in step 336 to discontinue the display of the second linked element. A decision is then made in step 338 whether to continue browsing operations in the GUI. If so, then browsing operations are continued, proceeding to step 302. Otherwise, logical landing zone operations are ended in step 340.

However, if it is decided in step 328 that the hot areas or image maps of the first and second linked elements are contiguous to one another, then the user moves their mouse cursor into the second linked element's area of the GUI. The user then interacts with the second linked element in step 332. A decision is then made in step 334 whether the mouse cursor is within the hot areas or image maps of the first and second linked elements. If so, then user interactions with the second linked element are continued, proceeding with step 332. Otherwise, a JavaScript onmouseout event is executed in step 336 to discontinue the display of the second linked element. A decision is then made in step 338 whether to continue browsing operations in the GUI. If so, then browsing operations are continued, proceeding to step 302. Otherwise, logical landing zone operations are ended in step 340.

However, if it is decided in step 318 that logical landing zones have been implemented, then a JavaScript onmouseout event is executed as the mouse cursor leaves the hot area or image map of the first linked element. When executed, the JavaScript onmouseout event activates the logical landing zones associated with the JavaScript onmouseout event. In one embodiment, the area of a first logical landing zone is defined and then coupled with the hot areas or image maps of the first and second linked elements to create a contiguous area within the GUI. As a result, the second linked area continues to be displayed as the mouse cursor is moved out of the hot area or image map of the first linked element. Execution of the JavaScript onmouseout event also prevents user interaction with other linked elements, or navigation aids, that are located within the first logical landing zone area. Once the mouse cursor is within the hot area or image map of the second linked element user interactions with the second linked area are performed in step 322. In another embodiment, the area of a second logical landing zone is defined to comprise the hot areas or image maps of the first and second linked elements and the area of the first logical landing zone. The second logical landing zone further prevents user interaction with other linked elements, or navigation aids, that are located within the second logical landing zone. In addition, the second logical landing zone defines boundaries, which if exceeded by the mouse cursor, will result in a JavaScript onmouseout event that will discontinue display of the second linked element and deactivate the first and second logical landing zones.

Accordingly, a decision is then made in step 324 whether the mouse cursor is within the first and second logical landing zone areas. If so, then interaction with the second linked element is continued, proceeding from step 322. Otherwise, a JavaScript onmouseout event is executed in step 326 to discontinue display of the second linked element and deactivate the first and second logical landing zones. A decision is then made in step 338 whether to continue browsing operations in the GUI. If so, then browsing operations are continued, proceeding to step 302. Otherwise, logical landing zone operations are ended in step 340.

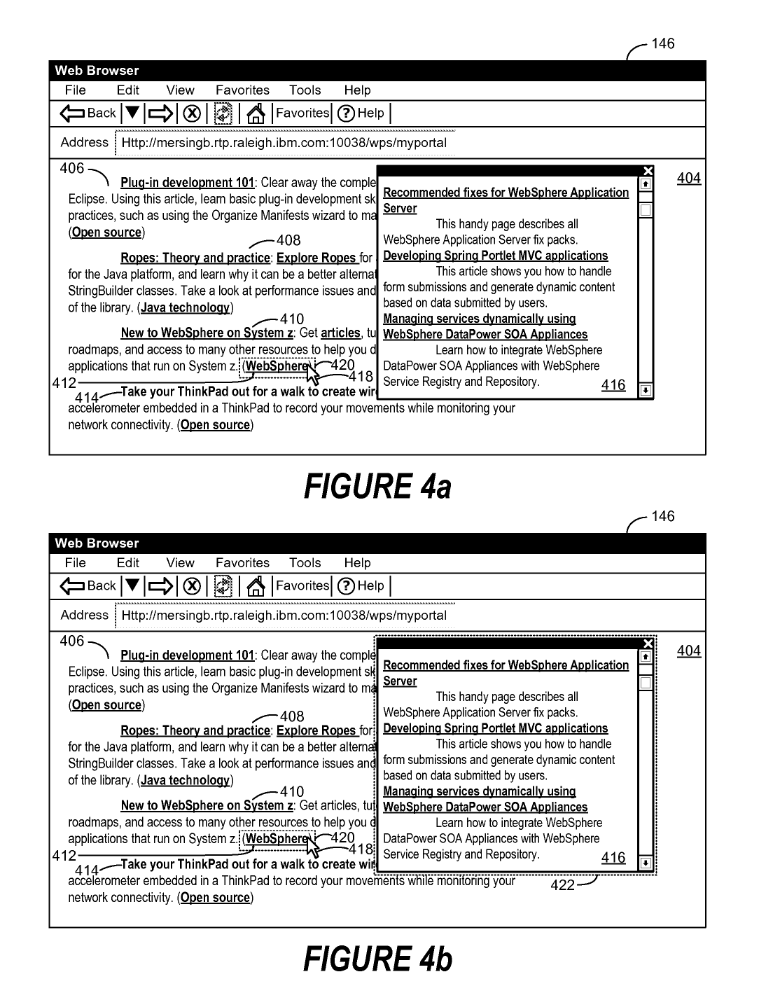

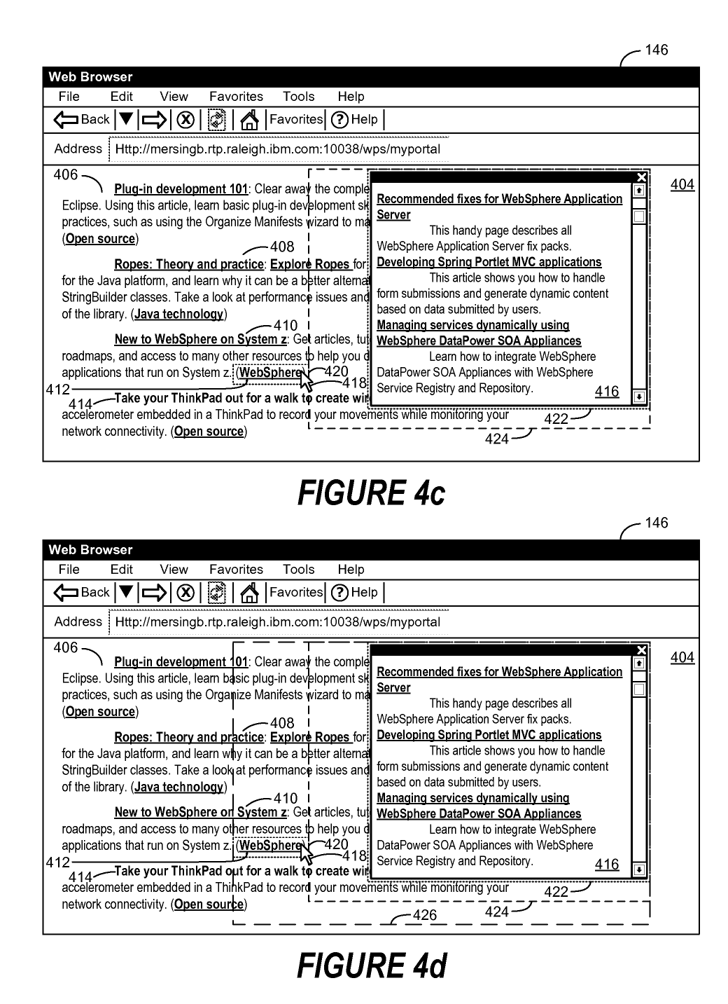

FIGS. 4a-d show logical landing zones as implemented within the graphical user interface (GUI) of a browser in accordance with an embodiment of the invention.

As shown in FIG. 4a, a browser 146 comprises a GUI window 404, further comprising content 406. Content 406 further comprises linked elements ‘A’ 408, ‘B’ 410, ‘C’ 412 and ‘D’ 414. A user gesture, such as hovering mouse cursor 418 over the hot area or image map area 420 of linked element ‘C’ 412 results in the execution of a JavaScript onmouseover event, which in turn results in the display of a linked element ‘E’ 416. In one embodiment, the execution of a JavaScript onmouseover event applies a visual attribute to the hot area or image map area 420 of linked element ‘C’ 412. As an example, a color may be applied to the hot area or image map area 420 of linked element ‘C’ 412 to signify its link relationship with linked element ‘E’ 416.

Referring now to FIG. 4b, the hot area or image map area 422 of linked element ‘E’ 416 is calculated. It will be apparent that the hot area or image map area 420 is not contiguous with the hot area or image map area 422. As a result, moving mouse cursor 418 outside of the hot area or image map area 420 will typically result in a JavaScript onmouseout event, which when executed, will discontinue the display of linked element ‘E’ 416.

FIG. 4c shows the implementation of a first logical landing zone 424. As shown in FIG. 4c, the first logical landing zone 424 comprises the hot area or image map area 422 of linked element ‘E’ 416 and is contiguous to the hot area or image map area 420 of linked element ‘C’ 412. As described in greater detail herein, the first logical landing zone 424 effectively expands the hot area or image map area 422 of linked element ‘E’ 416. As a result, moving mouse cursor 418 outside of the hot area or image map area 420 will result in a JavaScript onmouseout event. When executed, the JavaScript onmouseout event will result in the continued display of linked element ‘E’ 416 as long as the mouse cursor 418 remains within the hot area or image map area 420 or logical landing zone 424. In one embodiment, the JavaScript onmouseout event associated with the first logical landing zone 424 prevents user interaction with linked elements ‘A’ 408 and ‘D’ 414.

FIG. 4d shows the implementation of a second logical landing zone 426, comprising to the hot area or image map area 420 of linked element ‘C’ 412 and the first logical landing zone 424. In one embodiment, a JavaScript onmouseout event associated with the first logical landing zone 424 additionally prevents user interaction with linked element ‘B’ 410, as it is within the area of the second logical landing zone 426. Accordingly, linked element 416 continues to be displayed as the mouse cursor 418 is moved outside of the hot area or image map area 420 of linked element ‘C’ 412 or the first logical landing zone 424. However, the user is prevented from interacting with linked element ‘A’ 408 or ‘B’ 410. In another embodiment, moving mouse cursor 418 out of the second logical landing zone 426 results in a JavaScript onmouseout event that discontinues the display of linked element 416 and removes visual attributes applied to the hot area or image map area 420. In addition, the JavaScript onmouseout event also deactivates the first 424 and second 426 logical landing zones.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of skill in the art without departing from the scope and spirit of the invention. The embodiment was chosen and described to explain best the principles of the invention and the practical application, and to enable others of skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for managing elements within a graphical user interface (GUI), comprising:
linking a first element comprising a first GUI area to a second element comprising a second GUI area;
displaying the first element within the GUI;
receiving user input within the first GUI area, wherein the user input is a cursor operation operable to initiate the:
display of the second element within the GUI; and
activation of:
a third GUI area comprising the second GUI area, wherein the first and third GUI areas are contiguous; and
a fourth GUI area comprising the first and third GUI areas;
persisting the display of the second element while the cursor remains within the first and third GUI areas; and
deactivating the third and fourth GUI areas when the cursor exits the fourth GUI area.
discontinuing the display of the second element when the cursor exits the fourth GUI area.

2. The method of claim 1, wherein a JavaScript onmouseover event is generated by the user gesture with a cursor.

3. The method of claim 2, wherein execution of the JavaScript onmouseover event performs at least one of:
applying visual attributes to the first GUI area;
displaying the second element in the GUI;
generating the third GUI area;
generating the fourth GUI area; and
preventing user interaction with a third element located within the third GUI area.

4. The method of claim 1, wherein a JavaScript onmouseout event is generated when the cursor exits the fourth GUI area.

5. The method of claim 4, wherein execution of the JavaScript onmouseout event performs at least one of:
removing the visual attributes from the first GUI area
discontinuing the display of the second element;
deactivating the third GUI area; and
deactivating the fourth GUI area.

6. The method of claim 1, wherein the first, second, third and fourth GUI areas each comprise a polygon.

7. A system comprising:
a processor;
a data bus coupled to the processor; and
a computer-usable medium embodying computer program code, the computer-usable medium being coupled to the data bus, the computer program code managing elements within a graphical user interface (GUI) and comprising instructions executable by the processor and configured for:
linking a first element comprising a first GUI area to a second element comprising a second GUI area;
displaying the first element within the GUI;
receiving user input within the first GUI area, wherein the user input is a cursor operation operable to initiate the:
display of the second element within the GUI; and
activation of:
a third GUI area comprising the second GUI area, wherein the first and third GUI areas are contiguous; and
a fourth GUI area comprising the first and third GUI areas;
persisting the display of the second element while the cursor remains within the first and third GUI areas; and
deactivating the third and fourth GUI areas when the cursor exits the fourth GUI area.
discontinuing the display of the second element when the cursor exits the fourth GUI area.

8. The system of claim 7, wherein a JavaScript onmouseover event is generated by the user gesture with a cursor.

9. The system of claim 8, wherein execution of the JavaScript onmouseover event performs at least one of:
applying visual attributes to the first GUI area;
displaying the second element in the GUI;
generating the third GUI area;
generating the fourth GUI area; and
preventing user interaction with a third element located within the third GUI area.

10. The system of claim 7, wherein a JavaScript onmouseout event is generated when the cursor exits the fourth GUI area.

11. The system of claim 10, wherein execution of the JavaScript onmouseout event performs at least one of:
removing the visual attributes from the first GUI area
discontinuing the display of the second element;
deactivating the third GUI area; and
deactivating the fourth GUI area.

12. The system of claim 7, wherein the first, second, third and fourth GUI areas each comprise a polygon.

13. A computer-usable medium embodying computer program code, the computer program code comprising computer executable instructions configured for:
linking a first element comprising a first GUI area to a second element comprising a second GUI area;
displaying the first element within the GUI;
receiving user input within the first GUI area, wherein the user input is a cursor operation operable to initiate the:
display of the second element within the GUI; and
activation of:
a third GUI area comprising the second GUI area, wherein the first and third GUI areas are contiguous; and
a fourth GUI area comprising the first and third GUI areas;
persisting the display of the second element while the cursor remains within the first and third GUI areas; and
deactivating the third and fourth GUI areas when the cursor exits the fourth GUI area.
discontinuing the display of the second element when the cursor exits the fourth GUI area.

14. The computer usable medium of claim 13, wherein a JavaScript onmouseover event is generated by the user gesture with a cursor.

15. The computer usable medium of claim 14, wherein execution of the JavaScript onmouseover event performs at least one of:
applying visual attributes to the first GUI area;
displaying the second element in the GUI;
generating the third GUI area;
generating the fourth GUI area; and
preventing user interaction with a third element located within the third GUI area.

16. The computer usable medium of claim 13, wherein a JavaScript onmouseout event is generated when the cursor exits the fourth GUI area.

17. The computer usable medium of claim 16, wherein execution of the JavaScript onmouseout event performs at least one of:
removing the visual attributes from the first GUI area
discontinuing the display of the second element;
deactivating the third GUI area; and
deactivating the fourth GUI area.

18. The computer usable medium of claim 13, wherein the first, second, third and fourth GUI areas each comprise a polygon.

19. The computer usable medium of claim 13, wherein the computer executable instructions are deployable to a client computer from a server at a remote location.

20. The computer usable medium of claim 13, wherein the computer executable instructions are provided by a service provider to a customer on an on-demand basis.
